(19) United States
(12) Patent Application Publication
(10) Pub. No.: US 2014/0061267 A1
(43) Pub. Date: Mar. 6, 2014

(54) Interchangeable Scooter and Article Carrier System

(71) Applicants: Michael Hughesdon Turner, Arlington, VA (US); Ryan Patrick Murphy, Redondo Beach, CA (US)

(72) Inventors: Michael Hughesdon Turner, Arlington, VA (US); Ryan Patrick Murphy, Redondo Beach, CA (US)

(21) Appl. No.: 13/764,656

(22) Filed: Feb. 11, 2013

Related U.S. Application Data
(60) Provisional application No. 61/697,686, filed on Sep. 6, 2012.

(51) Int. Cl. B62J 9/00

(52) U.S. Cl. CPC B62J 9/003
USPC 224/413

(57) ABSTRACT

This inventive system provides a means to combine a scooter and an article carrier. A rigid frame attaches to one or more walls of the article carrier. A bracket attaches to the scooter and releasably engages the rigid frame. Thus, the bracket and the frame provide for selective attachment between a scooter and an article carrier. The bracket may be removed from the scooter and customized, allowing a variety of scooters to be combined with a variety of article carriers. An additional rigid member can be mounted to the bracket to contact and operate a scooter footboard latch.

### CROSS REFERENCE TO RELATED APPLICATIONS

This application claims benefit under 35 U.S.C. §119 of U.S. provisional patent application No. 61/697,686 filed on Feb. 10, 2012 and entitled “Interchangeable Scooter and Article Carrier System,” the entire contents of which are hereby incorporated by reference.

### BACKGROUND OF THE INVENTION

The purpose of the invention is to provide a system of interchangeable scooter and article carrier combinations to create scooter and backpack devices. In this way, a user may customize the combination with a particular scooter and a particular article carrier, depending on their needs. For example, a longer journey may call for a larger-wheeled scooter; or if sizeable loads are to be carried, a large article carrier may be needed. In this system, the user can easily select and combine which scooter to use with which carrier. Use of the resulting combination device reduces the travel time and the risk of injury when a user must travel long distances with heavy belongings.

Previous kick scooter and article carrier combination devices do not afford users this ability to customize the scooter and luggage portions of the combination device. They largely consist of kick scooter components, such as a footboard or steering handle, permanently attached to an article carrier, creating a device that can be carried or ridden. Thus, in many of these devices, the scooter steering handle and footboard are not connected, thereby placing immense stress on the article carrier while riding the combination. This can diminish, or entirely altogether eliminate, a user's ability to control the scooter when the carrier is comprised of flexible walls. Additionally, they do not teach a standalone scooter removably integrated into a standalone article carrier. Nor do they teach the concealment of certain scooter features within the article carrier. The present invention solves these problems with many other unique advantages.

### SUMMARY OF THE INVENTION

The present invention is a system of interchangeable article carrier and kick scooter components that combine to create a single device with multiple uses and separate devices with independent uses. This system is achieved through a set of interface units, where one interface unit is permanently, semi-permanently or releasably attached to the kick scooter and the corresponding interface unit is permanently, semi-permanently or releasably attached to the article carrier. The set of interface units function to releasably engage each other, forming a connection between the article carrier and the kick scooter. When connected, the device is stable and functional as either the article carrier or kick scooter. The article carrier, kick scooter, and interface units may take a variety of forms, shapes, and locations, as will be described herein. The interface unit attached to the carrier is referred to as the frame, and the interface unit attached to the scooter is referred to as the bracket.

The inventive system described herein is especially useful as a system that is compatible with a range of scooters, and other vehicle types, and a range of article carriers, enabling the user to customize the combination device for any particular situation. Examples include: an athlete who must carry large equipment would attach a duffel bag to her large scooter; a student who is only carrying a laptop computer and a small book would attach a slim backpack to his small scooter; or a beach visitor who would prefer a large tote bag to attach to their scooter. As the inventive system provides, these component article carriers and scooters are quickly and easily interchangeable.

### BRIEF DESCRIPTION OF THE DRAWINGS

FIGS. 1A-1E show the prior art.

FIGS. 2A-2C show the preferred embodiment of a bracket.

FIGS. 3A-3D show the preferred embodiment of bracket attachment to scooter.

FIGS. 4A-4D show the preferred embodiment of pedal attachment to bracket.

FIGS. 5A-5D show operation of a pedal.

FIGS. 6A and 6B show the preferred embodiment of bracket attachment to scooter.

FIGS. 7A-7C show the preferred embodiment of a steering lock.

FIGS. 8A and 8B show the preferred embodiment of a frame.

FIGS. 9A-9C show the preferred embodiment of frame attachment to scooter and bracket.

FIGS. 10A and 10B show the preferred embodiment of frame attachment to bracket.

FIGS. 11A-11E show the preferred embodiment of a frame cover.

FIGS. 12A-12C show the preferred embodiment of article carrier attachment to scooter.

FIGS. 13A and 13B show the preferred embodiment of the article carrier.

FIGS. 14A-14E show the preferred embodiment operation of article carrier attachment to scooter.

FIG. 15 shows an alternate view of article carrier attachment to scooter.

FIGS. 16A-16D show alternate embodiments of the bracket and bracket inserts.

FIGS. 17A-17D show alternate embodiments of the frame.

FIGS. 18A-18C show an alternate embodiment of the cap and a cap insert.

FIGS. 19A-19C show an alternate embodiment of the foot and a foot insert.

FIGS. 20A and 20B show an alternate embodiment of the frame.

FIGS. 21A and 21B show an alternate embodiment of the frame.

FIGS. 22A and 22B show an alternate embodiment of the frame and foot.

FIG. 23 shows a further alternate embodiment of the frame and foot.

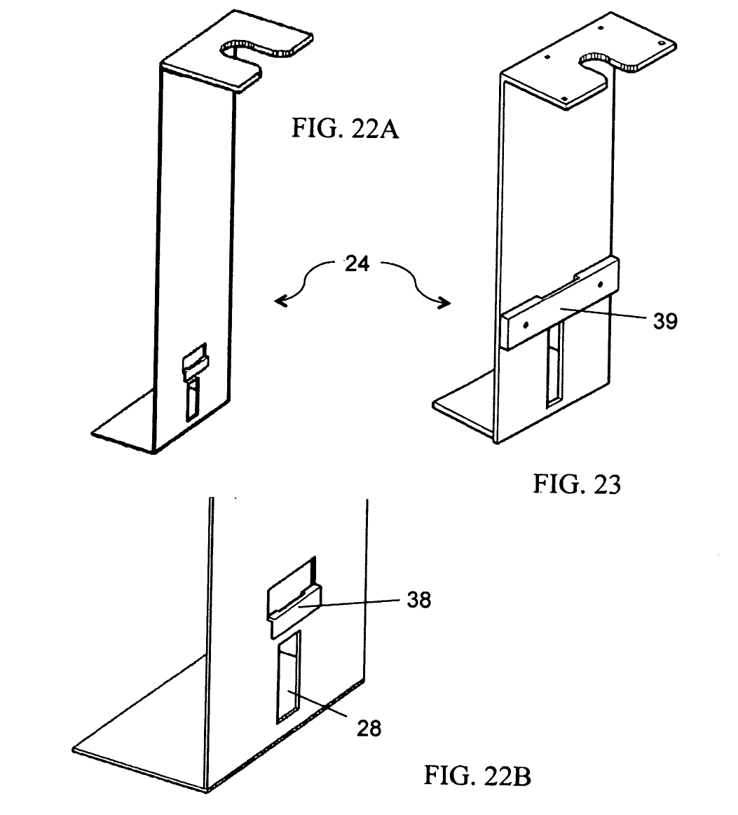

### DETAILED DESCRIPTION

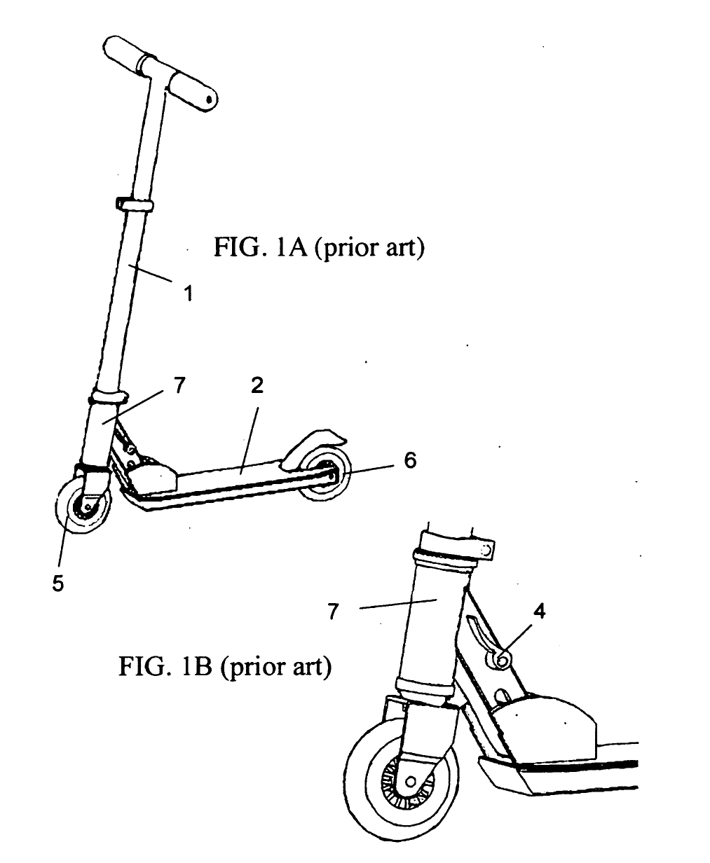

FIGS. 1A-1E show a conventional kick scooter. As shown in FIG. 1A, there is a scooter which has a general configuration of at least one front wheel 5, at least one rear wheel 6, a footboard 2 intended to support the weight of a rider, and a steering assembly 1 which provides directional control of a moving scooter through either rotation or tilting of a handlebar element. The scooter further includes a hub 7 which connects the footboard 2, steering assembly 1, and at least one front wheel 5. The scooter may be propelled either manually, such as through a user's foot placed upon the ground and “kicked,” or through use of a orbiting pedal, or through powered motive means, such as an electric motor.

Hub 7 may also include a footboard latch 4, which permits or prevents movement or rotation between footboard 2 and hub 7. Conventionally, footboard latch 4 is operated between at least two positions, see FIGS. 1C and 1D. Wherein in a first position, FIG. 1C, footboard 2 is prevented from rotating with respect to hub 7, and in a second, FIG. 1D, permitted to rotate. In this example, the rotation of footboard 2 causes the scooter to be either unfolded, as in FIG. 1D, or folded, as in FIG. 1E. Steering assembly 1 may also have a optional telescoping function, wherein steering assembly 1 expands or contracts between at least two positions. Additionally, the steering assembly 1 and footboard 2 may be controlled by any number of latches or locking mechanisms which hold elements of the steering assembly 1 or footboard 2 in place during use. However, none of the options or preferred forms described in this paragraph are required for this inventive system.

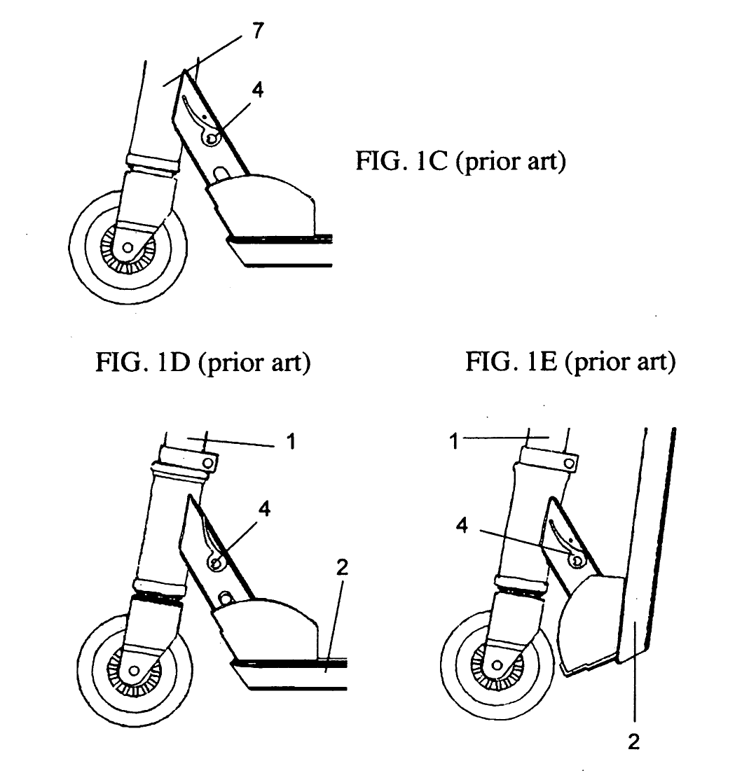

The inventive system is comprised of a set interface units, with one interface unit attaching to the article carrier, and a second attaching to a scooter. The interface unit on the scooter is known as a bracket 8, as seen in FIGS. 2A-2C. Bracket 8 is preferably comprised of two regions, one that which functions to attach to the scooter, and a second that engages the corresponding interface unit.

The first region, known as base 9, is comprised of a front wall 10 and two side walls 11. Front wall 10 and side walls 11 are configured to surround and attach to a portion of the scooter. Front wall 10 and side walls 11 may be of various shapes and orientations, but preferably are of equal dimension and arranged at approximate right angles to one another. Depending on the presence of a footboard latch 4 on the scooter, the front wall 10 and side walls 11 may have recesses to accommodate said footboard latch 4, as shown in FIGS. 2A and 2C. FIG. 2B shows a side wall 11 that does not include a recess. Preferably, side walls 11 further include attachment points 13 enabling the use of fasteners (not shown) to further secure base 9 to the scooter. Further preferably, front wall 10, includes at least one protrusion 14 that extends away from base 9. Protrusion 14 functions to releasably engage the corresponding interface unit attached to the article carrier, as will be discussed further below. And, while it is shown herein that protrusion 14 is located on front wall 10, in alternate embodiments it may be located on one or more side walls 11.

The second region, known as tab 3, extends away from base 9 and is shaped, sized, and positioned to provide additional releasable engagement with the corresponding interface unit attached to the article carrier. Preferably, tab 3 extends upwards from base 9 and has a sloped edge to facilitate engagement with the article carrier interface unit. Also preferably, tab 3 contains a second protrusion 14 on its face to further facilitate a secure engagement with the article carrier interface unit.

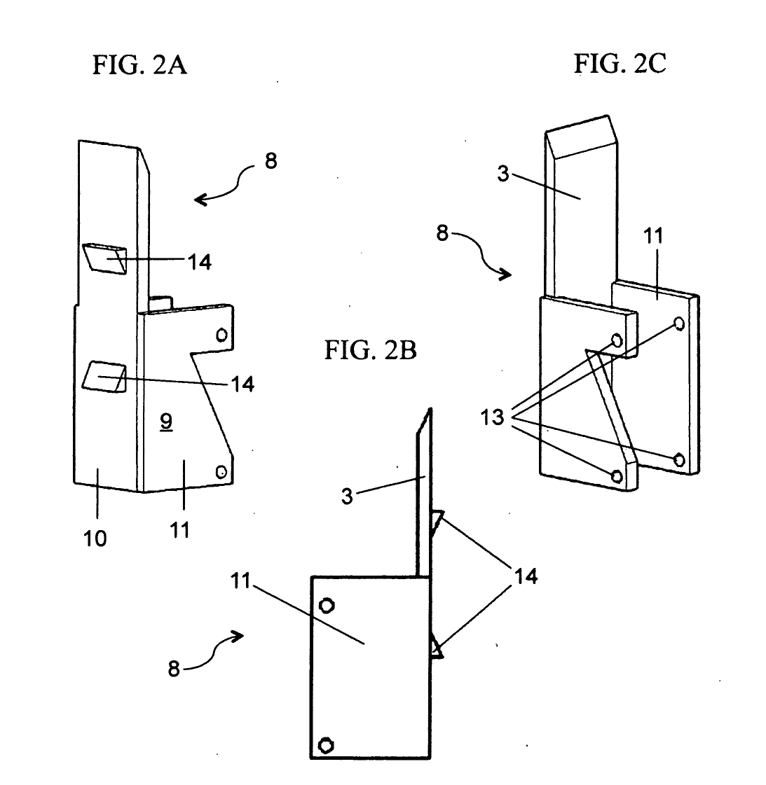

FIGS. 3A-3D show the attachment of bracket 8 to the scooter. In a preferred embodiment, the base 9 of bracket 8 attaches to a portion of the scooter that tends to remain fixed during riding, such as hub 7.

The bracket 8 may be releasably, semi-permanently, or permanently attached to the scooter. Preferably, bracket 8 is releasably attached to hub 7. Hub 7 is preferably comprised of two portions, a cylindrical portion 15 and an arm portion 16. Cylindrical portion 15 is generally rigid with one or more rotatable or pivotable connections to steering assembly 1 and front wheel 5. Arm portion 16 is also generally rigid and extends from the cylindrical portion 15 towards the footboard 2. Preferably, a distal end of this arm portion 16 is comprised of a pivotable joint for connection to footboard 2. Further preferably, footboard latch 4 is located on a face of arm portion 16.

In FIG. 3A, the bracket 8 is apart from hub 7, but positioned for engagement. In FIG. 3B bracket 8 is placed on and attached to hub 7, surrounding the cylindrical portion 15 and a portion of arm portion 16. FIG. 3C is an alternate view of FIG. 3B. There, footboard latch 4 is shown as located within a recess of side wall 11. FIG. 3D shows a preferred embodiment where a fastener 17 extends between attachment points 13 on side walls 11, creating a more secure attachment to hub 7. Fastener 17 may be of any type commonly known in the art, such as a bolt, screw, dowel, or the like. In the preferred embodiment, fastener 17 extends through attachment points 13, over a top face of arm portion 16 of hub 7.

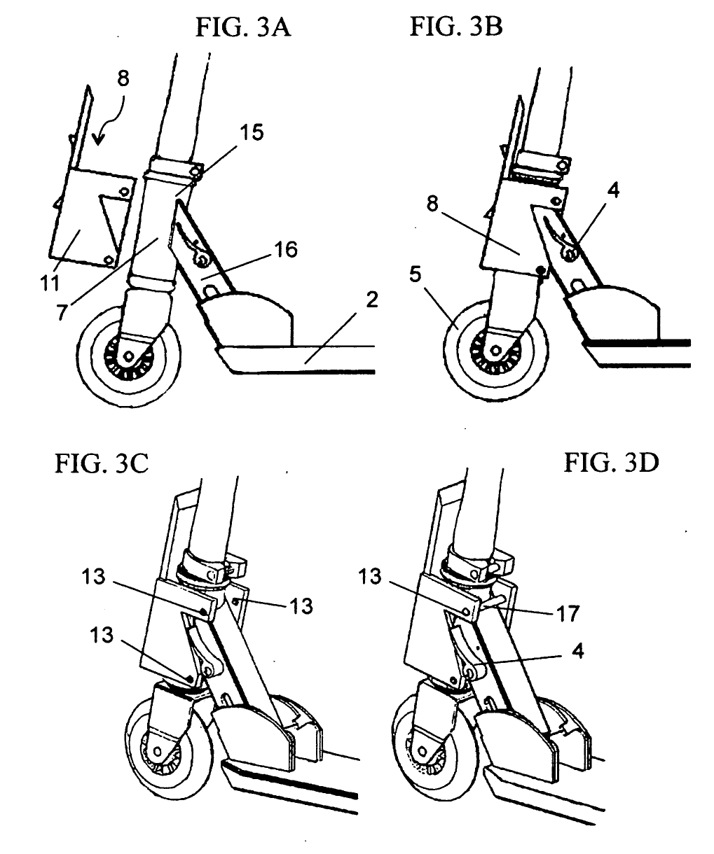

FIGS. 4A-4D show an alternate embodiment of bracket 8. In this embodiment, pedal 18, shown in FIG. 4A, is connected to a portion of base 9 of bracket 8, as shown in FIGS. 4B-4C. Pedal 18 is connected in such a way to allow for movement relative to bracket 8, preferably rotation. Pedal 18 may take various shapes and sizes, but, in a preferred embodiment, is generally planar with at least two extensions 19 and 20 located on opposite sides of a rotation point 21. Extension 19 is configured to contact footboard latch 4, while extension 20 is configured to contact a user's foot. To facilitate contact with a foot, extension 20 preferably extends away from hub 7 in a direction perpendicular to the plane of extension 19.

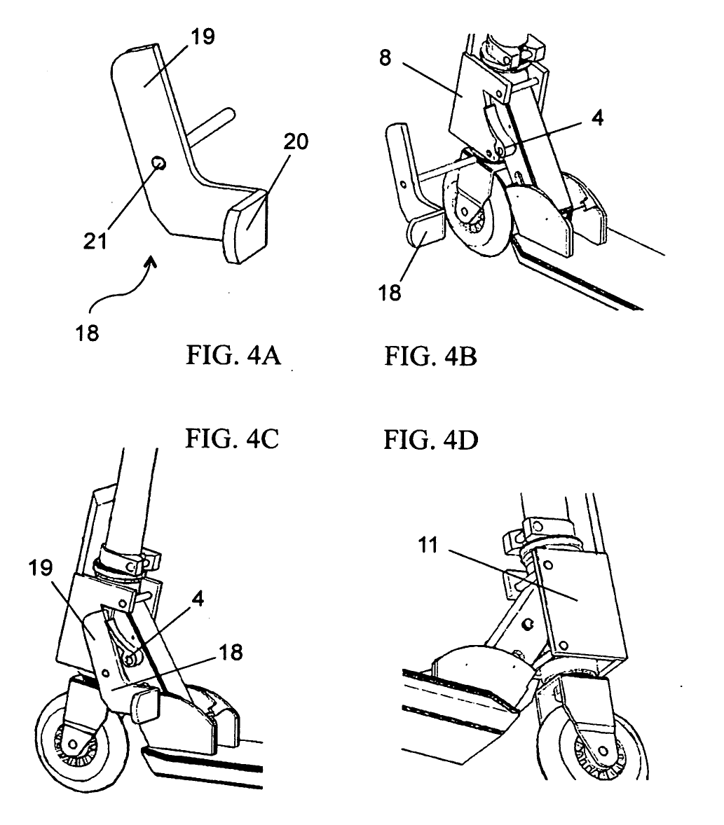

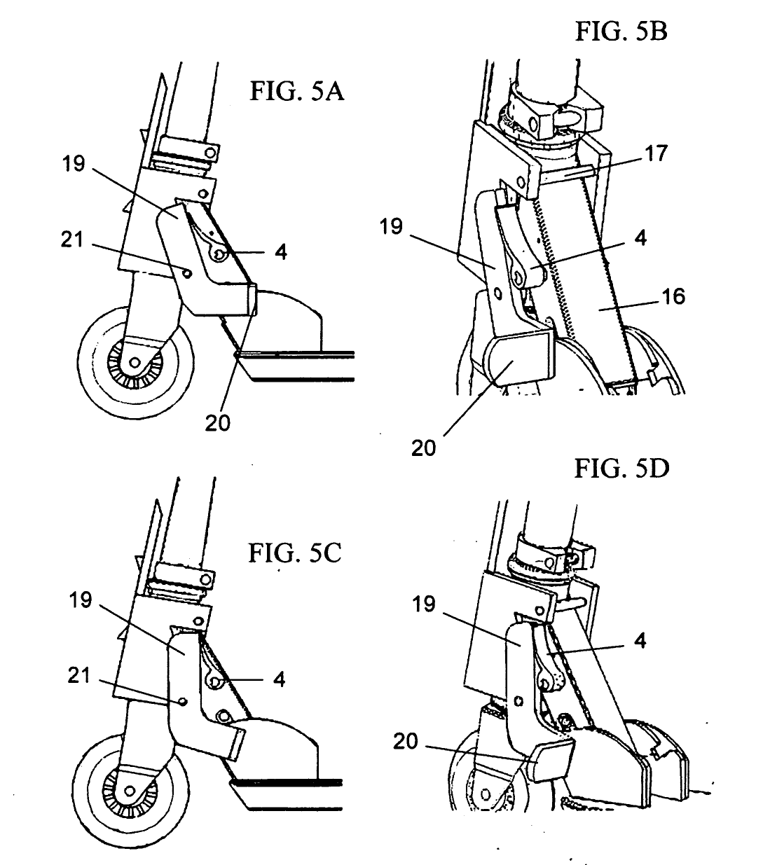

Further preferably, pedal 18 attaches to base 9 through additional attachment points 13, in a manner similar to fastener 17, as shown in FIG. 4B. In this way, pedal 18 provides additional securement of base 9 to hub 7, by passing below arm portion 16. This allows for rotation of pedal 18 with respect to bracket 8. The function of pedal 18 is to increase the ease of operating footboard latch 4, should there be a footboard latch on the scooter. In this embodiment pedal 18 allows footboard latch 4 to be operated by foot as well as by hand. FIGS. 5A-5D show the interaction between pedal 18, bracket 8, and footboard latch 4. In FIGS. 5A and 5B, footboard latch 4 is in the first position, contacting extension 19 of pedal 18, but not moved thereby. When extension 20 of pedal 18 is pushed down by a user's foot, pedal 18 rotates about rotation point 21, causing extension 19 to contact and operate footboard latch 4. This can be seen in FIGS. 5C and 5D. In this position, footboard latch 4 allows footboard 2 to rotate to a folded position. Pedal 18 is preferably made out of the same material as the frame, whether that be plastic, wood, or metal. FIG. 4D shows side wall 11 that is on the opposite side of hub 7 from footboard latch 4. Side wall 11 may include a recess if the shape of the hub 7 and footboard latch 4 require it. FIGS. 6A and 6B show an alternate view of the bracket 8, with pedal 18, attached to hub 7.

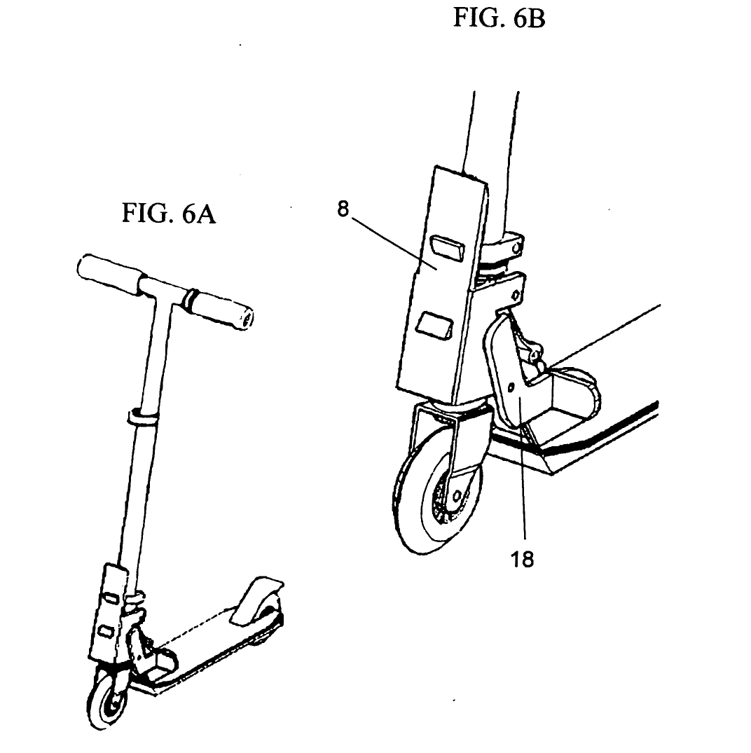

While there are various configurations of hubs 7 and steering assemblies 1 in the scooters of the prior art, it is typical for a base clamp 22 to be located at the base of steering assembly 1, as shown in FIGS. 7A-7C. The function of base clamp 22 is to surround steering assembly 1 and secure it to hub 7 through a compressive fit. Further typically, base clamp 22 is circular in shape but has a clamp protrusion 23 that is configured to allow for adjustment to the degree of compression.

In the alternate embodiment of FIGS. 7A-7C, tab 3 and base clamp 22 function together to restrict rotation of steering assembly 1. In FIG. 7A, steering assembly 1 is rotated to a first position where clamp protrusion 23 extends away from a side of steering assembly 1 opposite to tab 3 of bracket 8. In this embodiment, clamp protrusion 23 extends away from steering assembly 1 farther than the distance between upward extending tab 3 and steering assembly 1. In FIG. 7B, the user has rotated steering assembly 1 to a second position, generally a 180° rotation. In this second position, clamp protrusion 23 contacts and deflects tab 3 away from steering assembly 1. This can be seen in FIGS. 7B and 7C. The frictional and directional forces from the contact between clamp protrusion 23 and tab 3 may be designed such that significant force is needed to further rotate steering assembly 1 and clamp protrusion 23 out of contact with tab 3. Thus, while in contact, tab 3 effectively prevents rotation of steering assembly 1, functioning as a steering lock. This can be advantageous during certain modes of use of the combination scooter and article carrier device. It should be noted that this functionality does not contact or interfere with the potential operation of pedal 18 and footboard latch 4.

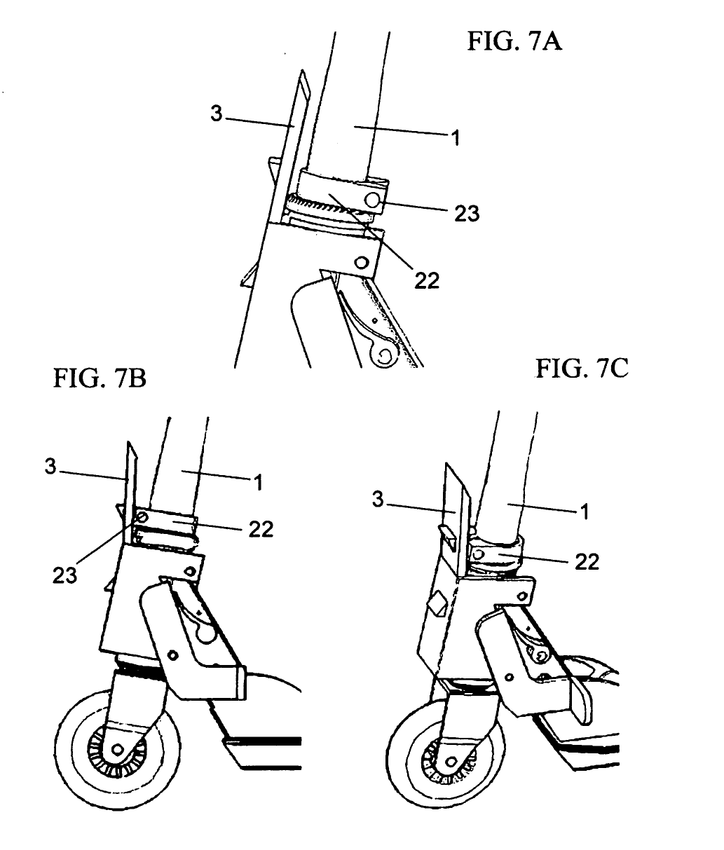

FIG. 8A shows the interface unit that is attached to the article carrier, known as a frame 24. Frame 24 has two primary functions, provide a stable connection to the bracket 8 and support the walls of the article carrier and the contents contained therein. Thus, frame 24 may be made out of a variety of materials, but preferably is of a rigid or semi-rigid material, such as plastic, wood or metal.

To serve its functions, frame 24 is generally comprised of a vertical portion and one or more horizontal portions, as shown in FIG. 8A. Frame 24 may be of unitary construction, or may be comprised of several attached parts, also shown in FIG. 8A. Frame 24 may further be located internal or external to the article carrier, but preferably internal, and may also be comprised of lateral walls that function to further support and shape the article carrier (not shown).

In the preferred embodiment, as shown in FIG. 8B, frame 24 is made of two frame halves 25, where each frame half 25 has vertical and horizontal portions, generally in an L-shape. Optionally, each frame half 25 has one or more rails 26, wherein the rails 26 run across the vertical portion of the frame half. 25. Preferably, each frame half 25 has two rails 26, which run across the vertical portion of frame half 25. The rails have have a thickness approximately equal to the thickness of tab 3 on bracket 8, the advantages of which will be described further below. Each frame half 25 is also comprised of an aperture 28. Aperture 28 may be located on either the vertical or horizontal portions, but preferably, the vertical. Each frame half 25 is further comprised of a recess 29. Recess 29 is approximately the size and shape of steering assembly 1, and is located on a distal edge of the horizontal portion of the frame half 25. Preferably, but not necessarily, frame halves 25 are identical for advantages in manufacturing, and are joined together with a joining plate 27. Joining plate 27 is generally a planar piece which may be made of a material similar to the frame halves 25, but may alternatively be more or less rigid or of a different shape.

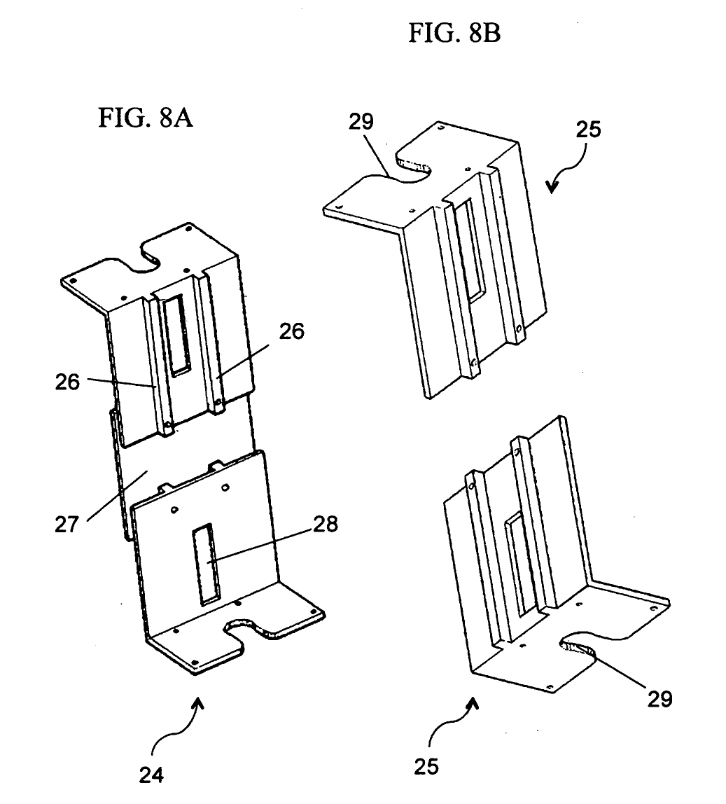

FIGS. 9A-9C show the attachment of frame 24 to the scooter, through releasable engagement with both the steering assembly 1 and the bracket 8. Recess 29 is shaped so as to be able to be pressed on to a portion of steering assembly 1, preferably in a temporarily deformable manner. Once pressed on, significant force is required to remove recess 29 from around steering assembly 1. In the preferred embodiment, recess 29 engages steering assembly 1 and prevents relative horizontal translation therebetween, but allows for relative rotation. This is advantageous and necessary for those scooters that twist steering assembly 1 to steer. In an alternative embodiment, recess 29 is tight around steering assembly and does not permit rotation or translation therebetween. This is advantageous for scooters that tilt, rather than twist, the steering assembly 1 to steer. In either embodiment, the connection between recess 29 and steering assembly 1 prevents frame 24 from translating horizontally with respect to the steering assembly 1, but allows for vertical translation, or sliding, and rotation between the two.

The interaction between tab 3 of bracket 8 and frame 24 is shown in FIG. 9B. In the preferred embodiment, tab 3 is placed alongside the vertical portion of lower frame half 25 between rails 26 and on a face opposite the horizontal section. FIG. 9C shows the same relative positions of tab 3 and frame halves 25 as attached to a scooter. Further in the preferred embodiment, tab 3 is permitted to slide up alongside the vertical portion of the lower frame half 25, into a position between frame half 25 and joining plate 27 (not shown). Tab 3 is permitted to move into this position because rails 26 are of a similar thickness and separate the frame half 25 from joining plate 27 an amount equal to that thickness. Once inserted into this gap, tab 3 functions to prevent horizontal movement of the frame 24, prevent the article carrier 31 from falling with respect to the scooter, and prevent rotation of the frame 24 with respect to the hub 7 and footboard 2. These functions are critical when the contents of the article carrier 31 shift around during use.

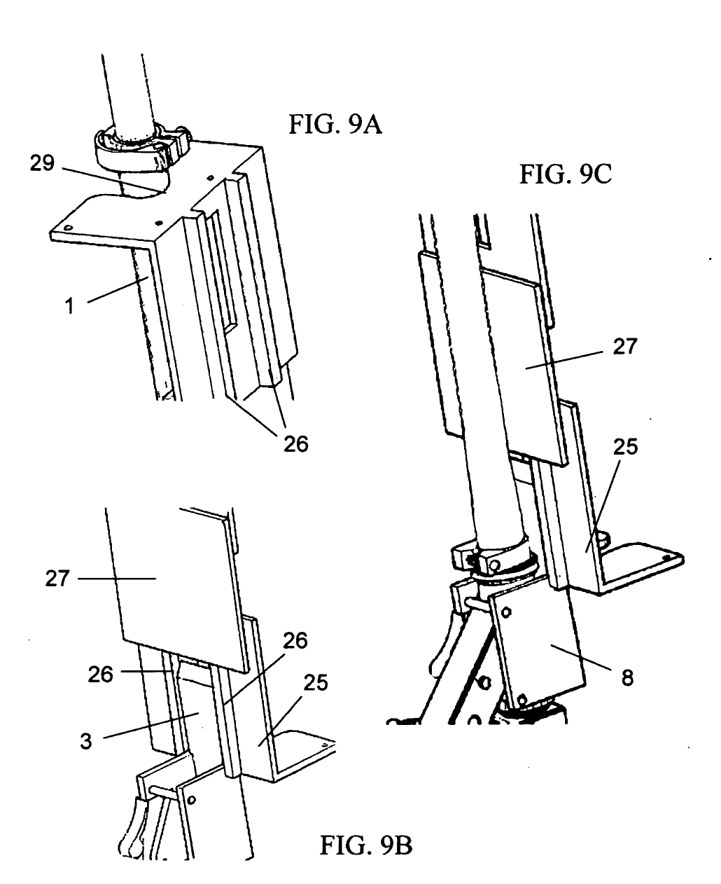

FIG. 10A is an alternate view of FIG. 9C. Here, a top protrusion 14, located on a face of tab 3, has entered aperture 28 on the lower frame half 25. In FIG. 10B, the frame 24 has been lowered on to the engagement position, causing tab 3 to move into the position between frame half 25 and joining plate 27. This movement also causes a bottom protrusion 14, located on front wall 10 of bracket 8, to enter aperture 28. Preferably, top and bottom protrusions 14 are positioned so as to have a tight fit against the inside perimeter of aperture 28. Further preferably, but not necessarily, protrusions 14 should have at least one sloped side to facilitate entry into aperture 28. The engagement between the protrusions 14 and aperture 28 is advantageous because it prevents frame 24 from moving upward or downward with respect to the scooter. They can also serve as a visual or tactile indicator to the user that the frame 24 is mounted correctly on to the bracket 8 of the scooter.

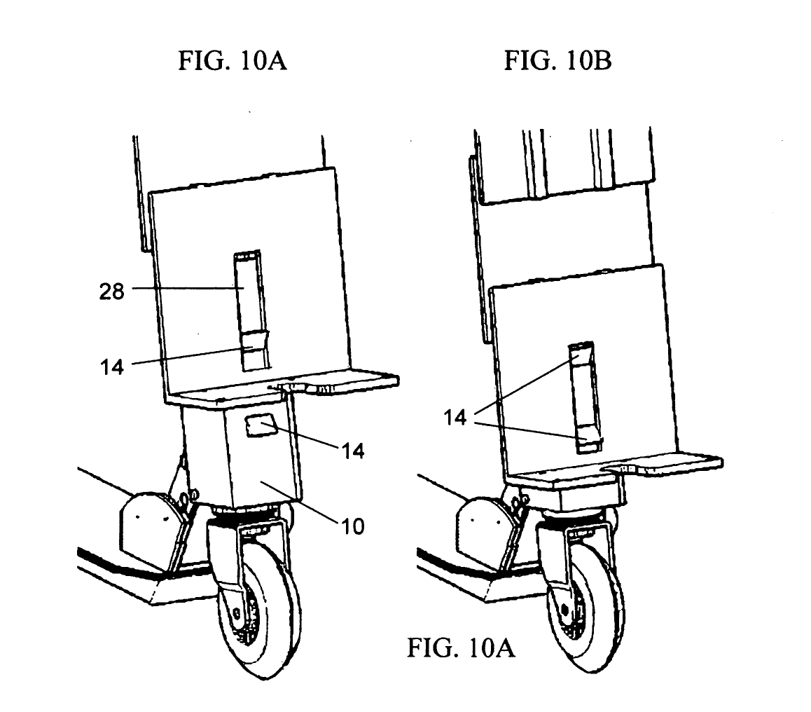

FIGS. 11A-11E show an alternate embodiment, wherein a frame cover 30 is designed to substantially cover a face of frame 24. Frame cover 30 provides certain advantages, such as a uniform appearance for the frame 24 and protection of frame 24 from the contents of the article carrier. Frame cover 30 is preferably made out of a soft material, such as foam, cloth, heavy cardboard or plastic, and attaches to the frame 24 at various points for a secure connection.

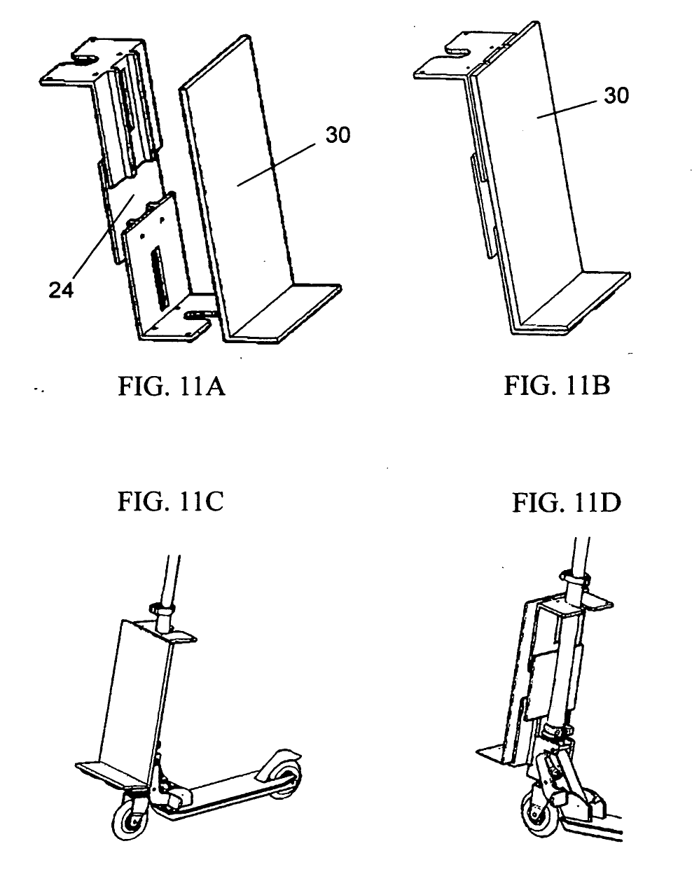

FIGS. 12A-12C show an article carrier 31 attached to a scooter using the present inventive system. In this embodiment frame 24 is inside article carrier 31. Article carrier 31 may be comprised of rigid or flexible walls to contain a user's belongings therein, and be of varying sizes, styles and shapes, including, but not limited to: suitcases, tote bags, duffel bags or, preferably, backpacks. As shown in FIG. 12C, the recess 29 of frame 24 surrounds steering assembly 1, and tab 3 is positioned between joining plate 27 and frame 24. In this position, the protrusions 14 (not shown) have entered and are inside of aperture 28, creating, together with recess 29, a secure attachment between article carrier 31 and the scooter. Horizontal portions of frame halves 25 are secured to the walls of the article carrier 31 through any known means, such as rivets, screws, velcro, adhesives, fabric fasteners, or the like. Joining plate 27 and frame halves 25 are sized so as to tightly and aesthetically fit into the vertical space of article carrier 31. The horizontal portion of the lower frame half 25 is advantageous in that it supports the bottom wall of the article carrier 31 and the carrier's contents, and keeps certain scooter components away from the user's back while the device is worn as an article carrier, such as front wheel 5.

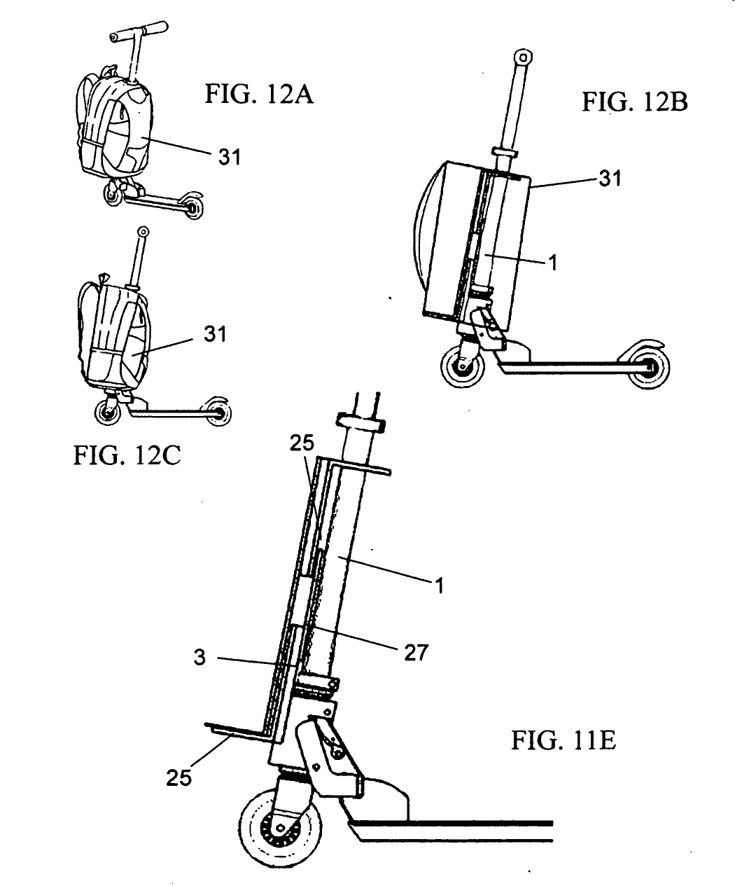

FIGS. 13A and 13B show an outside view of article carrier 31. In the preferred embodiment, frame 24 is located internal to article carrier 31. In order to allow frame 24 to engage the steering assembly 1 and bracket 8, article carrier 31 is comprised of closable openings 32. Closable openings 32 are located on top and bottom faces of article carrier 31, or any other faces through which steering assembly 1 is intended to pass. Closable openings 32 may be closed with any closure or fastener known in the art, such as buttons, zippers, buckles, velcro, or the like. Closable openings 32 are also sized to accommodate passage of the steering assembly 1 or bracket 8 therethrough. If the scooter has a collapsible handlebar 12 as part of the steering assembly 1, then top and bottom closable openings 32 are sized to accommodate the collapsible handlebar 12.

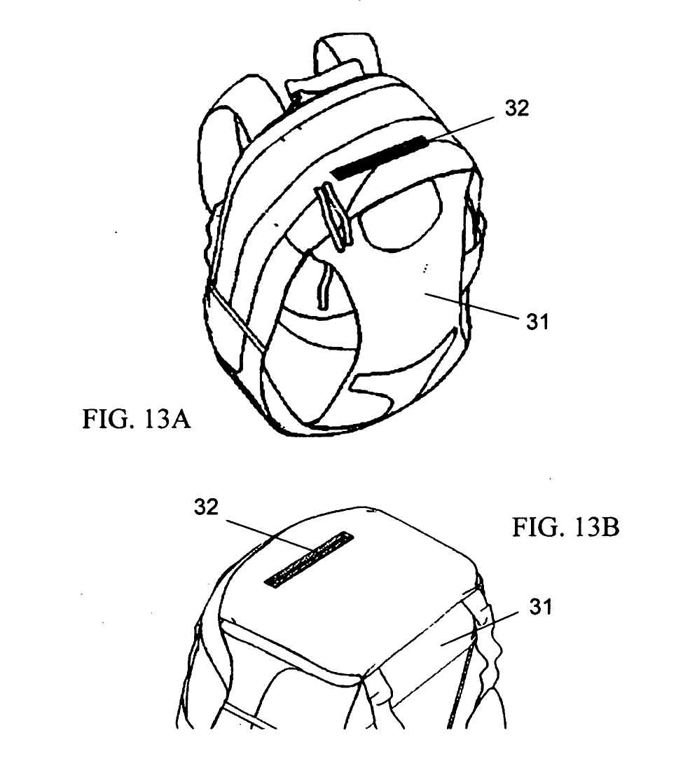

FIGS. 14A-14D show the preferred embodiment and method of attaching article carrier 31 to the scooter. In this preferred embodiment, the article carrier 31 takes the form of a traditional backpack: flexible-walled, with shoulder straps to be worn or carried by a user, and a main closeable opening to access belongings contained therein. The frame 24 is located within the article carrier 31, and generally lies against a vertical wall of the article carrier 31 opposite from one or more shoulder straps. The preferred method includes insertion of steering assembly 1 into the closable opening 32 (not shown) on a bottom face of article carrier 31, through closable opening 32 (not shown) on a top face, and then to a position beyond the top face of article carrier 31.

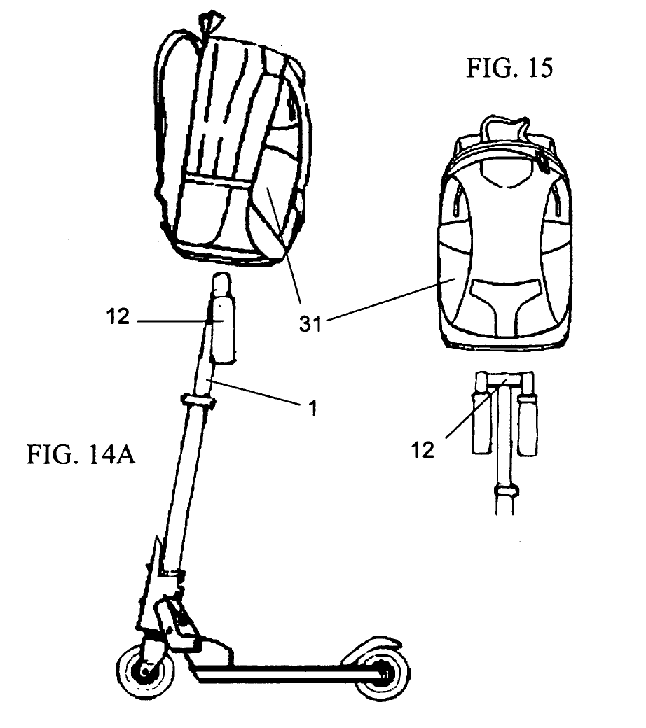

FIGS. 14A and 15 show the first step of the preferred method. Here, article carrier 31 is positioned above steering assembly 1. Closable openings 32 are in the open position. In FIG. 14B, the steering assembly 1 has passed partially through article carrier 31. In FIG. 14C the steering assembly 1 has passed all the way through article carrier 31, but not so far as to place both protrusions 14 through aperture 28 on frame 24. In FIG. 14D, the article carrier 31 and frame 24 therein are in the lowest position. Tab 3 is now between joining plate 27 and frame half 25, and both protrusions 14 have entered aperture 28. In FIG. 14E, the recess 29 of frame 24 is pressed on to steering assembly, completing attachment of article carrier 31 to the scooter. Also, at least extension 20 of pedal 18 extends out through closable opening 32 and is accessible by a user. Here, the combination device is fully assembled and resistant to separation. In an alternate embodiment of this method, recess 29 of frame 24 is pressed on to steering assembly 1 prior to lowering the frame 24 on to tab 3.

In either embodiment, the method of separating the article carrier 31 from the scooter is generally opposite to the method of attachment. The preferred method begins with the pulling the bottom of frame 24 away from bracket 8, and lifting upwards. This motion disengages protrusions 14 from aperture 28, and tab 3 from between joining plate 27 and frame half 25. Next, the top of frame 24 is pulled away from steering assembly 1 so as to cause disengagement with recess 29. With both closable openings 32 in the open position, steering assembly 1 is free to be removed through the bottom face of article carrier 31. When separate, the scooter is free to be used independently without interference from bracket 8, and the article carrier 31 as a container when closable openings 32 are in the closed position.

There are various alternative embodiments to the frame 24 and bracket 8 that provide distinct advantages, and are discussed below.

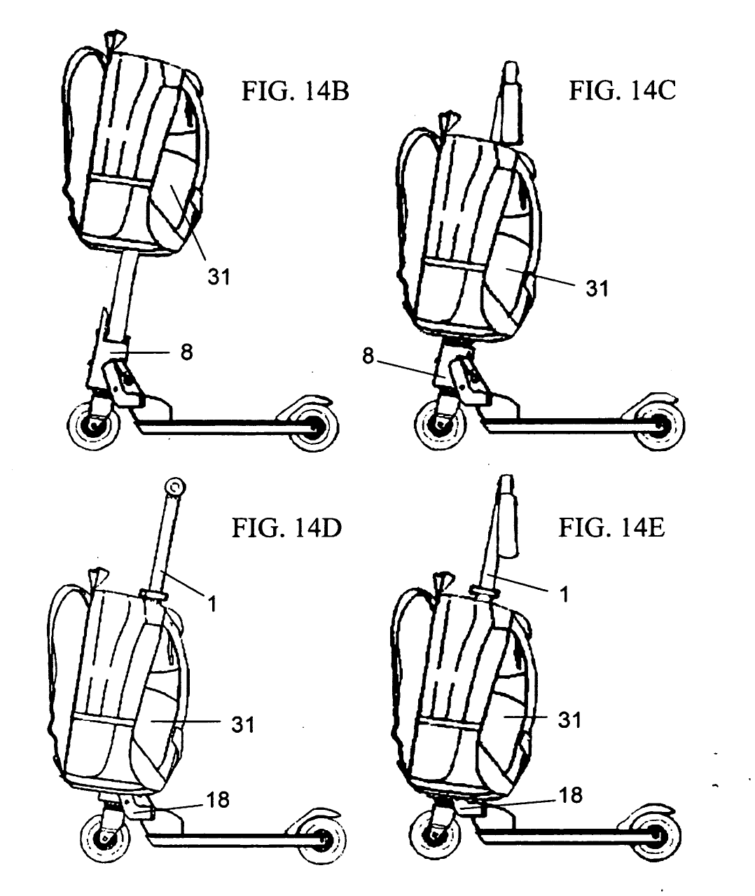

FIGS. 16A-16D show an alternate embodiment where bracket 8 is further comprised of one or more inserts 33. The inserts 33 are generally planar and preferably lie on the outside faces of the side walls 11 of the bracket 8, as shown in FIGS. 16A-16C. The inserts 33 are further comprised of one or more attachment points that secure the insert to side wall 11, and to receive fasteners 17 around cylindrical portion 15 and arm portion 16 of scooter hub 7. The use of inserts 33 allows a single bracket 8 to be attached to hubs 7 of various sizes and shapes, and to simultaneously provide for proper positioning of pedals 18. Inserts 33 may be attached to bracket 8 by any known means in the art, such as screws, rivets, or adhesives and the like. FIG. 16D shows a non-limiting example of insert 33 configurations. In an alternate embodiment, inserts 33 may be attached to inside faces of the side walls 11 of bracket 8.

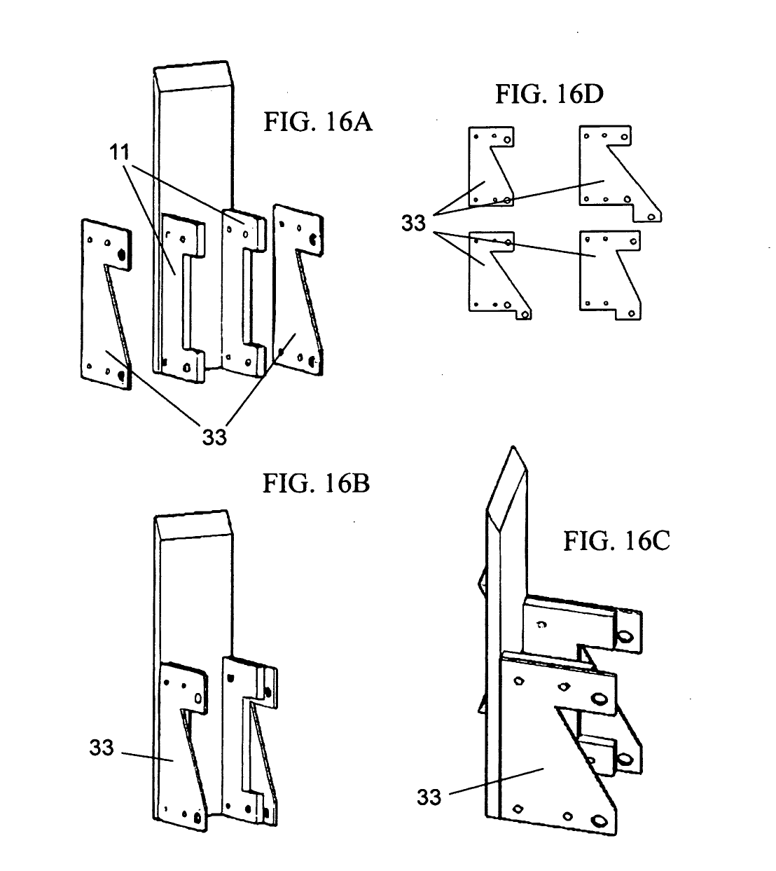

FIGS. 17A-17D show alternate embodiments of joining plate 27, where a shorter or taller joining plate 27 can decrease or increase the overall height of frame 24. This is advantageous for adapting the frame to variously dimensioned article carriers 31.

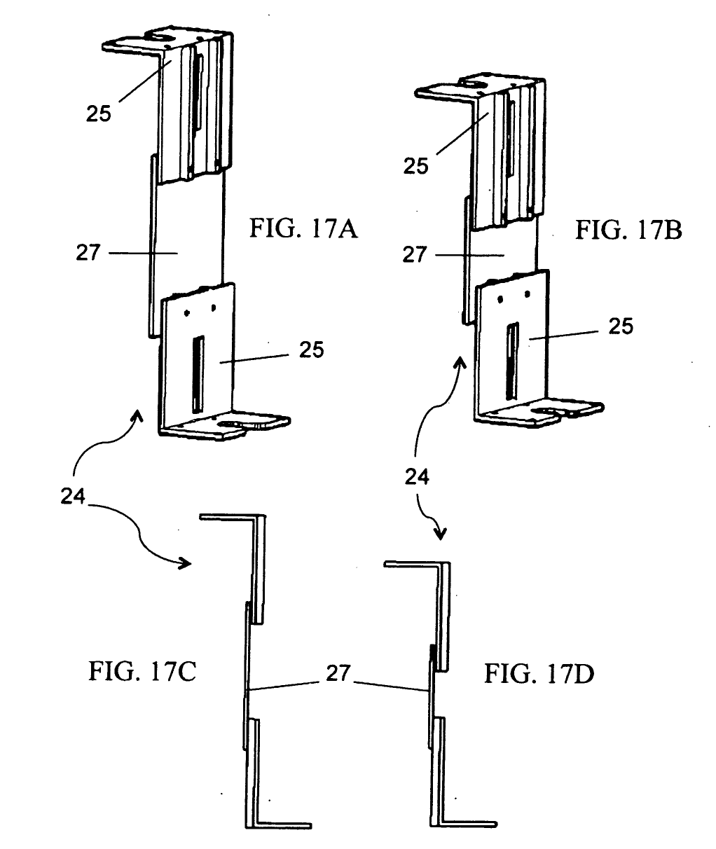

FIGS. 18A-18C show an alternate embodiment where a cap 34 is placed on and attached to the horizontal portion of an upper frame half 25. Cap 34 is preferably planar and dimensioned to match the overall shape of the horizontal portion of the frame half 25, but its recess 35 may differ in location, shape, or size from recess 29. This is advantageous in the event the user wishes to use the inventive system with a scooter whose steering assembly 1 is too small for engagement with recess 29. In an further alternate embodiment, cap 34 is placed below horizontal portion of an upper frame half 25.

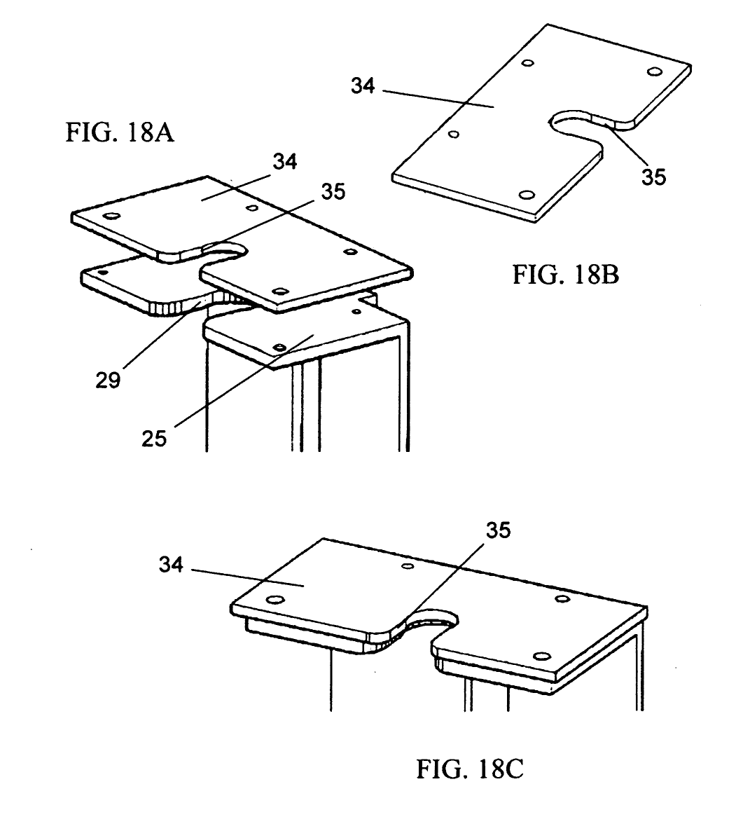

FIGS. 19A-19C show an alternate embodiment where a foot 36 is placed on and attached to the horizontal portion of a lower frame half 25. Foot 36 is preferably planar, rigid or semi-rigid, and dimensioned to match the overall shape of at least a portion of the bottom face of article carrier 31. Thus, the shape of foot 36 may be rectangular or, in the alternative, circular, triangular, crescent or the like. Use of foot 36 in this preferred way creates an aesthetic appearance for the article carrier 31 and helps support the contents contained therein, keeping them off of the ground and away from interference with front wheel 5. In a further alternate embodiment, foot 36 is placed below the horizontal portion of the lower frame half 25.

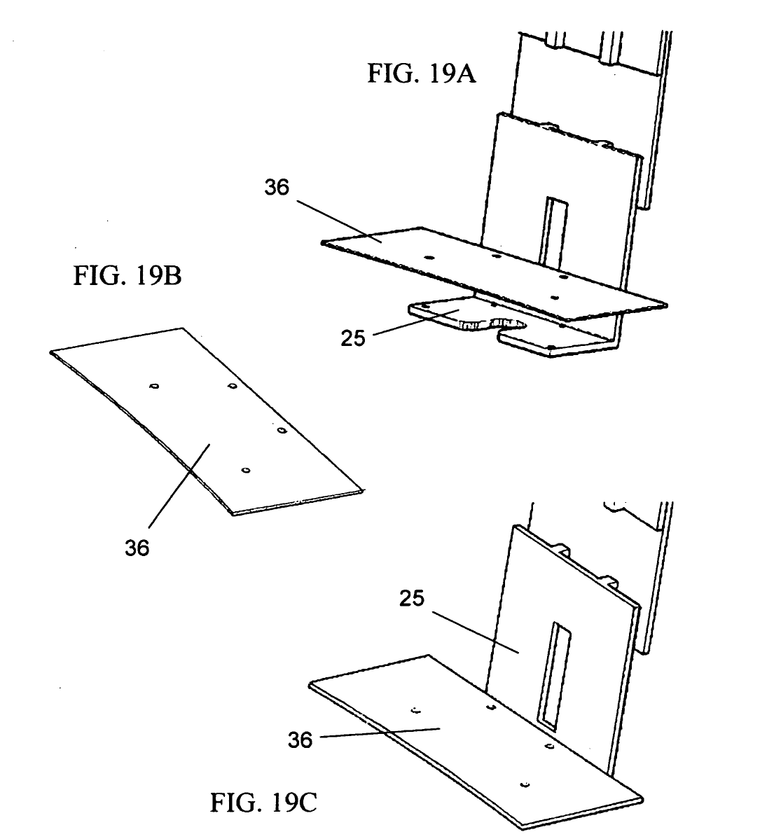

FIGS. 20A and 20B show an alternate embodiment where frame halves 25 are sized so as to overlap and eliminate the need for a joining plate 27. Here, one frame half 25 has rails 26 along its vertical portion face. The other frame half 25 has corresponding walled channels 37 in place of rails 26. The channels 37 are sized so that rails 26 fit inside in a nesting fashion. The nested rails 26 and channels 37 strengthen the connection between the two frame halves 25, in addition to any other conventional fasteners that may be used.

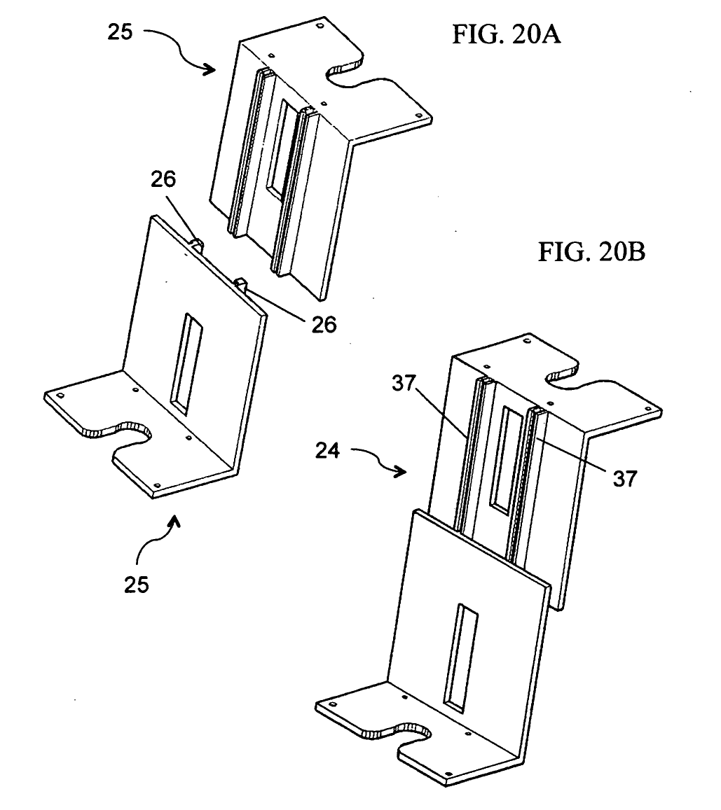

FIGS. 21A and 21B show an alternate embodiment where frame halves 25 are also sized so as to overlap and eliminate the need for a joining plate 27. Here each frame half 25 has a rail 26 along a vertical portion. When overlapping, the rails 26 of each frame half 25 are in contact along their leading faces. In this alternative embodiment, each rail 26 has a height of one half the thickness of tab 3, to allow for passage of tab 3 between frame halves 25.

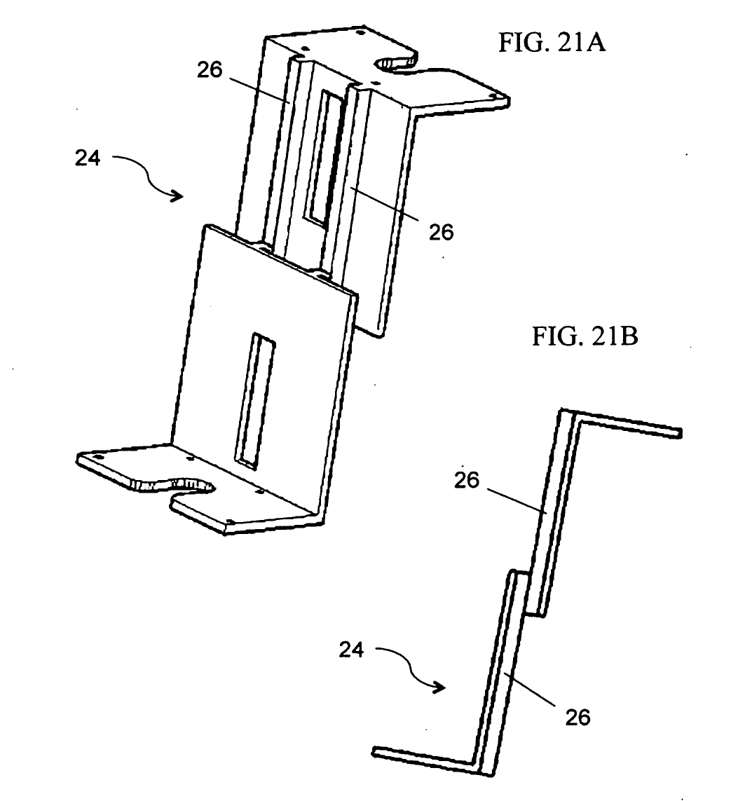

FIGS. 22A, 22B and 22C show further alternate embodiments, wherein the frame 24 is of unitary construction. The embodiment of frame 24 in FIG. 22A lacks a joining plate 27 and overlapping halves 25, but includes a hook 38 for engagement with tab 3. Hook 38 is designed to curl out and away from frame 24, as shown in FIG. 22B, to receive tab 3 and may be centrally or laterally located on frame 24. To accomplish this, hook 38 is dimensioned to match the width and thickness of tab 3. In a further alternate embodiment, a separate crossbar 39 can be fastened to receive tab 3 and position protrusions 14 through aperture 28.

Preferably, the frame halves 25, joining plate 27, cap 34 and foot 36 are permanently attached to one another by means of any known acceptable fastener such as rivets, screws, nuts and bolts, adhesives and the like. In an alternate embodiment they are semi-permanently attached to one another by means of any known acceptable fastener, such as deformable plugs and apertures, magnetics, hooks-and-loops, clasps, latches, or and the like.

Further preferably, the material of the frame halves 25, joining plate 27, cap 34 and foot 36 is acrylonitrile butadiene styrene (“ABS”) plastic, which is inexpensive, lightweight, and commonly available in sheets. Although light-weight metals and other hard plastics may serve as substitutes.

Although a few embodiments of the present invention have been shown and described, it will be appreciated by those skilled in the art that changes may be made in these embodiments and components of the system may be operably used independently from one another, without departing from the principles and spirit of the invention, the scope of which is defined in the claims and their equivalents.

We claim:

1. A system for attachment of an article carrier to a vehicle, comprising:
a bracket;
a frame inside of said article carrier;
wherein said bracket is removably attached to a hub of said vehicle;
wherein said frame is removably attached to said bracket;
wherein said frame is further removably attached to a steering member of said vehicle.

2. An attachment for a land vehicle, comprising:
a front wall;
two side walls;
wherein said front wall connects the two side walls;
a fourth wall, wherein said fourth wall extends from said front wall in the same plane as said front wall;
and at least one protrusion on a face of said front wall, away from the face towards the side walls.

3. An attachment for an article carrier, comprising:
a frame member, comprised of at least a vertical portion and two horizontal portions;
wherein said horizontal portions are located at opposite ends of said vertical portion, and extend away from said vertical portion in opposite perpendicular directions;
and wherein at least one of said horizontal portions includes a recess along a leading edge.
